(19) United States
(12) Patent Application Publication
(10) Pub. No.: US 2005/0149213 A1
(43) Pub. Date: Jul. 7, 2005

(54) Media file management on a media storage and playback device

(75) Inventors: Chris J. Guzak, Kirkland, WA (US); Ken Tubbs, Bellevue, WA (US); Oliver Lee, Redmond, WA (US); Christopher J. Araman, Seattle, WA (US); Kris J. Krueger, Duvall, WA (US); Jerry D. Smith, Redmond, WA (US); Anton Phillip Sohn, Woodinville, WA (US); Roberto A. Franco, Seattle, WA (US)

Correspondence Address: LEE & HAYES PLLC, 421 W RIVERSIDE AVENUE SUITE 500, SPOKANE, WA, 99201, US

(73) Assignee: Microsoft Corporation

(21) Appl. No.: 10/751,680

(22) Filed: Jan. 5, 2004

(51) Int. Cl. G06F 17/00; H04R 29/00

(52) U.S. Cl. 700/94; 381/58

(57) ABSTRACT

System and methods for managing content on a media device such as a portable digital audio device are described. The system recognizes when a digital audio device is connected to a computer and it automatically notifies a user that the audio device is connected and provides an entry point through which content of the audio device can be managed. The audio device is presented in an extended namespace (UI extension) of an operating system user interface in the same manner that typical storage devices (e.g., hard drives and floppy drives) are presented by the operating system user interface. Contents (e.g., music files) of the audio device are manageable through the UI extension in the same familiar manner as the contents of other typical storage devices of the computer.

### TECHNICAL FIELD

The present disclosure relates to file management on a media storage and playback device, and more particularly, to an operating system user interface that enables viewing and managing of files on such a device when the device is connected to a computer.

### BACKGROUND

The storage capacity of media devices such as portable digital audio player devices is ever-increasing. The available memory on portable digital audio devices may range from about 64 megabytes (MB), which is suitable for storing about 15 MP3 fommatted songs, to as high as 20 gigabytes (GB), which can store as many as 5000 MP3 songs. The increasing capacity for such devices to store more and more music files makes file management a significant factor in the overall user experience. The most common way to load music files onto a digital audio device is to save them onto a computer, such as a desktop or laptop PC, after “ripping” the files from a CD or downloading them from the Internet. The music files can then be transferred from the PC to the audio device by connecting the audio device to the PC.

Digital audio device manufacturers write specific file management applications for their audio devices that enable users to transfer music files from their PCs to their audio devices. Thus, before transferring and managing music files on an audio device, a user installs a management application from a CD that comes with the device, and learns how to use the management application. Management applications provided by audio device manufacturers generally work well as tools to manage music files on respective audio devices.

However, the device-specific nature of such management applications has various disadvantages. One disadvantage is the added cost that device manufacturers incur in writing and providing the management applications for each audio device. In addition, the file management experience for users may vary widely in look and feel from one audio device to another. More importantly, the file management experience provided by such management applications may be generally unfamiliar to a user by comparison to a more familiar file management experience provided by an operating system such as a Windows® operating system from Microsoft®. Furthermore, for any given device, a user must install a particular file management application onto the PC and spend time learning how the software works in order to begin transferring and managing files on the audio device. In general, current methods of managing files on audio devices are costly and result in an inconsistent user experience across the wide range of audio devices and an inconsistent user experience with respect to the more familiar file management experience provided by computer operating systems.

Accordingly, there is a need for a way to provide a more consistent and less costly user experience with respect to file transfer and management on digital audio devices.

### SUMMARY

A system and related methods are described for managing media files on a media storage and playback device.

In accordance with one implementation, an operating system recognizes a digital audio device that is connected to a computer. The operating system creates a shell namespace extension to its user interface (i.e., a UI extension) for the digital audio device. The audio device is presented in the UI extension and content on the audio device can be managed through the UI extension.

In accordance with another implementation, upon recognizing the connection of a digital audio device to a computer, an operating system automatically notifies the user of the audio device and provides an entry point to manage the audio device through an extension to the operating system user interface. A dialog box permits the user to open the digital audio device and manage contents of the digital audio device through the extension.

### BRIEF DESCRIPTION OF THE DRAWINGS

The same reference numerals are used throughout the drawings to reference like components and features.

FIG. 1 illustrates an exemplary environment suitable for managing content on a digital audio device.

FIG. 2 illustrates an exemplary block diagram representation of various components of a PC and a digital audio device.

FIG. 3 is an exemplary screen shot of an operating system user interface that includes a namespace extension for an audio device.

FIG. 4 is an exemplary screen shot of an operating system user interface illustrating the contents of an audio device.

FIG. 5 is an exemplary screen shot of an operating system user interface illustrating transferring a file from a folder on a PC to an audio device.

FIG. 6 is an exemplary screen shot of a dialog box that notifies a user of an audio device and provides an entry point to an operating system user interface to manage the contents of an audio device.

FIG. 7 is an exemplary screen shot of an operating system user interface illustrating sorting the contents of an audio device.

FIG. 8 illustrates a block diagram of an exemplary method for managing content on a digital audio device.

FIG. 9 illustrates an exemplary computing environment suitable for implementing a PC such as that shown in the exemplary environment of FIG. 1.

### DETAILED DESCRIPTION

Overview

The following discussion is directed to a system and methods for managing content on a media device such as a portable digital audio device. The system recognizes when a digital audio device is connected to a computer and it automatically notifies a user that the audio device is connected and provides an entry point through which content of the audio device can be managed. The audio device is presented in an extended namespace (UI extension) of an operating system user interface in the same manner that typical storage devices (e.g., hard drives and floppy drives) are presented by the operating system user interface. Contents (e.g., music files) of the audio device are manageable through the UI extension in the same familiar manner as the contents of other typical storage devices of the computer.

Advantages of the described system and methods include reducing software development costs for audio device manufacturers, reducing the time needed for users to become familiar with managing content on an audio device, and providing a more consistent user experience with respect to managing content on an audio device through a familiar operating system user interface.

Exemplary Environment

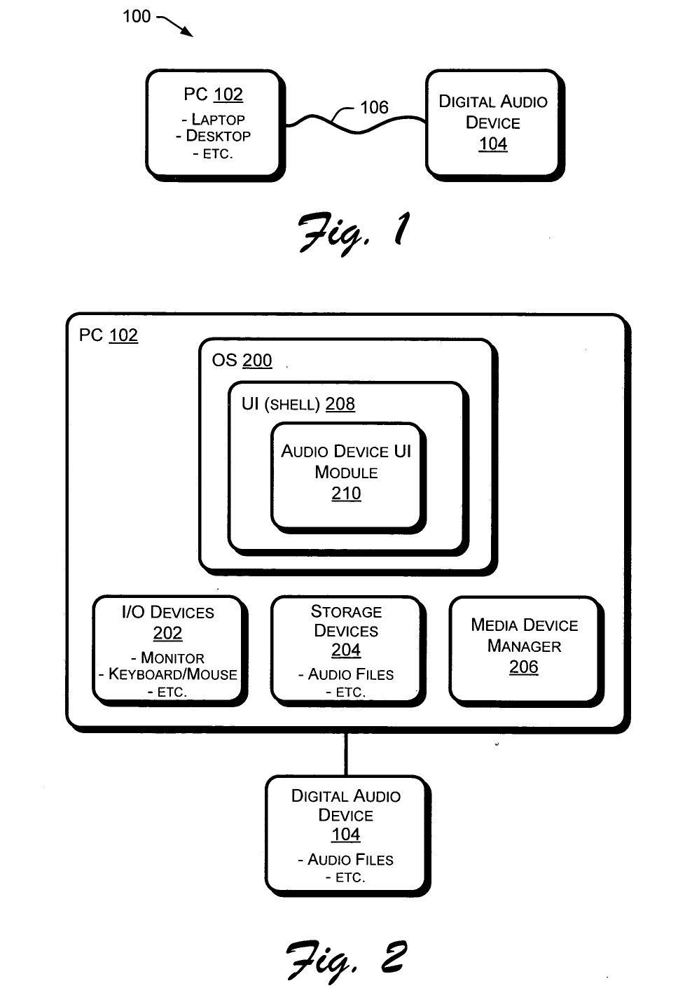

FIG. 1 shows an exemplary environment 100 suitable for providing management of content on a portable audio device through the operating system user interface (OS UI) of a computer. The exemplary environment 100 includes a computer such as a desktop or laptop PC 102 and a digital audio device/player 104. The PC 102 and audio device 104 are operatively coupled at various times through connection 106. Connection 106 is typically a USB or FireWire connector through which content is transferred to, and managed on, audio device 104 by PC 102. However, connection 106 is not necessarily limited to a local USB or FireWire connector, and in another embodiment connection 106 may be a remote connection including any one or a combination of a modem, a cable modem, a LAN (local area network), a WAN (wide area network), an intranet, the Internet, or any other suitable communication link.

PC 102 may be implemented as any of a variety of conventional computing devices including, for example, a desktop PC, a laptop PC, a notebook or other portable computer, a workstation, and so on. PC 102 is capable of acquiring media content (e.g., music files) from various sources and managing the content on audio device 104. PC 102 may acquire music files for audio device 104 in various ways including by “ripping” the files from a CD or by downloading the files from the Internet. Thus, PC 102 usually has access to content sources through a network connection (not shown) that may include any one or a combination of a modem, a cable modem, a LAN (local area network), a WAN (wide area network), an intranet, the Internet, or other suitable communication link. PC 102 is otherwise typically capable of performing common computing functions, such as email, calendaring, task organization, word processing, Web browsing, and so on. In this embodiment, PC 102 runs an open platform operating system, such as a Windows® operating system available from Microsoft® Corporation of Redmond, Wash. One exemplary implementation of a PC 102 is described in more detail below with reference to FIG. 9.

Audio device 104 receives audio content from PC 102 and stores the content for playback through a speaker or headphones. Audio content includes variously formatted music files such as MP3 (MPEG-1 Audio Layer 3) files or WMA (Windows Media Audio) files. Audio device 104 may be implemented as any one of numerous digital audio devices available from various manufacturers. Examples of a digital audio device 104 may include Sonicblue's Rio Riot and Rio Karma, Archos' Jukebox Recorder 20, Creative's Nomad MuVo and Nomad Jukebox 3, Apple's ipod, and so on.

Different audio devices 104 include varying amounts of storage capacity and varying features. For example, the available memory on a portable digital audio device 104 may range from about 64 megabytes (MB), which is suitable for storing about 15 MP3 formatted songs, to as high as 20 gigabytes (GB), which can store as many as 5000 MP3 songs. Examples of different features that may be offered by different audio devices 104 include multiple file format playback, playlist generation, multiple search functions, random playback, equalization, AM/FM radio tuner, a screen for displaying a playlist and a currently playing song in text, and so on.

### Exemplary Embodiments

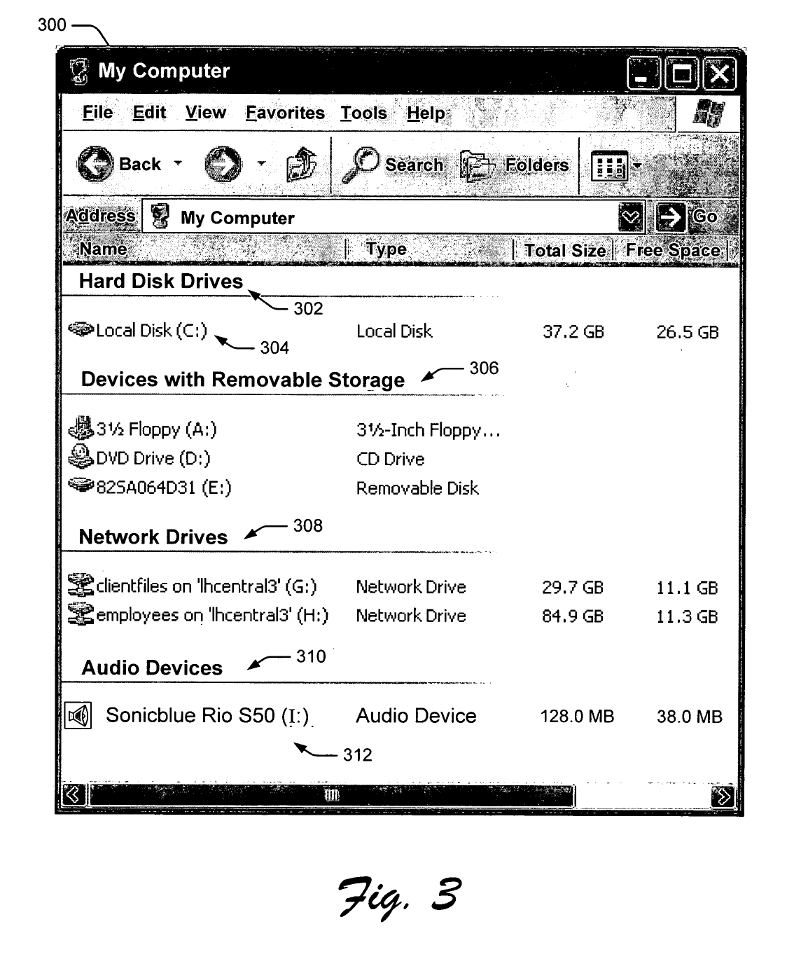

FIG. 2 is a block diagram representation of an exemplary PC 102 which is suitable for providing management of content on a portable digital audio device 104 through an operating system user interface (OS UI). PC 102 includes an operating system (OS) 200. In this embodiment, OS 200 is a Windows® operating system such as Windows XP available from Microsoft® Corporation. Also illustrated on PC 102 of FIG. 2 are input/output devices 202 (e.g., display monitor, keyboard, mouse), storage devices 204 (e.g., hard drive, floppy drive, CD drive), and a media device manager module 206. It is to be understood that PC 102 includes various resources (not shown in FIG. 2) such as processing and memory (e.g., RAM) resources that enable the storage and execution of various components discussed herein. Such resources are described in detail in an exemplary implementation of a PC 102 discussed below with reference to FIG. 9.

Media device manager 206 is a component that enables the transfer of files to and from a non-PC device, such as a portable digital audio device 104, in a standardized way. Applications on PC 102 can instantiate media device manager 206 to get information about service providers and transfer digital media content. Access to digital content on a portable digital audio device 104 is provided through various interfaces of device manager 206. Interfaces are used to enumerate and traverse objects, such as folders and files, on the audio device 104. Media device manager 206 identifies portable digital audio devices 104 connected to PC 102 provided that they are installed, properly registered, and are currently connected and powered on. One example of a media device manager 206 is Windows Media Device Manager available from Microsoft® Corporation.

Operating system 200 includes a user interface (OS UI) 208, or shell, which provides users with access to a wide variety of objects necessary for running applications and managing the operating system. The most numerous and familiar of these objects are the folders and files that reside on disk drives of PC 102. There are also usually a number of virtual objects that allow the user to do tasks such as sending files to remote printers or accessing the Recycle Bin. The OS UI 208, or shell, organizes these objects into a hierarchical namespace, and provides users and applications with a consistent and efficient way to access and manage objects.

Included as part of the OS UI 208 is an audio device user interface (UI) module 210. Audio device UI module 210 is configured to communicate with a portable digital audio device 104 to enable a user to manage content on the audio device 104. In one embodiment, audio device UI module 210 is configured to communicate on its own with audio device 104, and in another embodiment it is configured to communicate with audio device 104 through media device manager 206. Although audio device UI module 210 may be discussed as communicating with audio device 104 through media device manager 206, it is to be understood that the functionality in device manager 206 enabling such communication can readily be included in audio device UI module 210 such that communication via a media device manager 206 would be unnecessary. In general, audio device UI module 210 generates and manages a portable audio device shell namespace extension of the OS UI 208 that provides users with a consistent way to manage their portable digital audio devices 104. Audio devices 104 that are compatible with the media device manager 206 and/or audio device UI module 210, will automatically show up in the shell namespace when the devices 104 are connected to PC 102. Users can interact with the contents of a connected audio device 104 in a consistent manner to perform basic operations such as copying, deleting, and renaming music files.

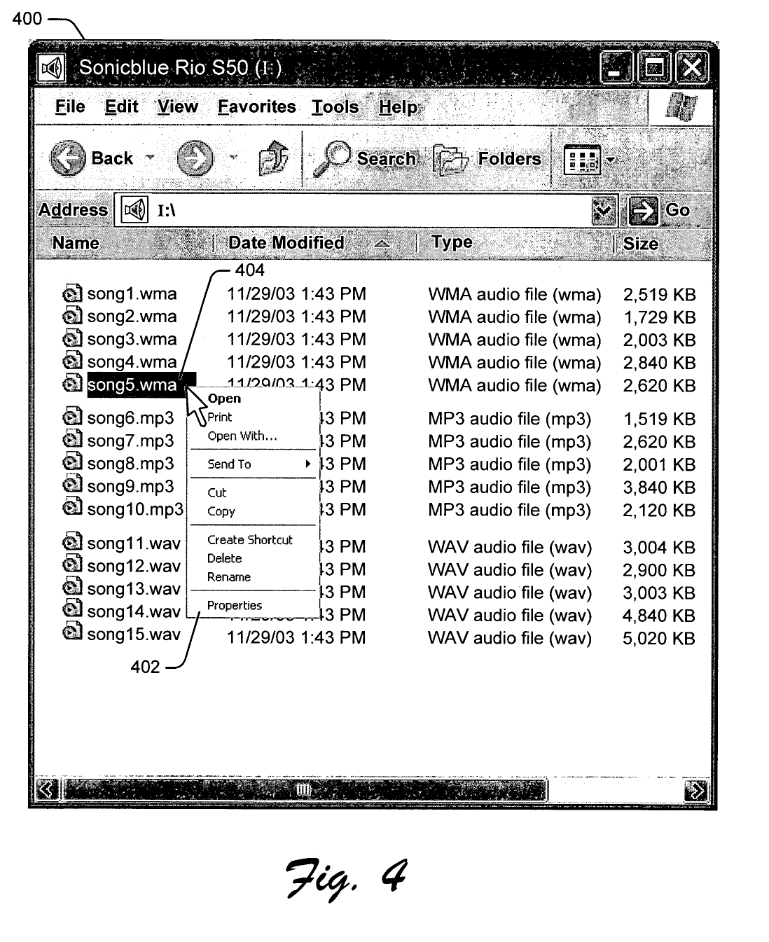

FIG. 3 illustrates an exemplary screen shot 300 generated by the OS UI 208 upon connection of a compatible audio device 104 to PC 102. Screen shot 300 illustrates a typical OS UI 208 that provides a user with access to objects that are on or are connected to PC 102, and which enable the user to run application programs and manage the operating system 200. Thus, screen shot 300 illustrates a “Hard Disk Drive” namespace 302 in which a local hard disk drive (C:) 304 is presented, a “Devices with Removable Storage” namespace 306 which presents several devices of the PC 102 that provide for removable storage (i.e., floppy drive (A:), DVD drive (D:), removable drive (E:)), and a “Network Drives” namespace 308 in which network drives (G:) and (H:) are presented.

In addition, audio device UI module 210 is configured to automatically provide an “Audio Devices” namespace 308 in the OS UI 208 when a compatible audio device 104 is connected to PC 102. Thus, screen shot 300 includes “Audio Devices” namespace 308 which presents a connected audio device 104 called “Sonicblue Rio S50” 312. The OS UI 208 through the audio device UI module 210, has organized the objects that are on or connected to PC 102, including the “Sonicblue Rio S50” 312 audio device 104, into a hierarchical namespace and has provided the user with a consistent and efficient way to access and manage each of these objects. Thus, the management of files on a connected audio device 104 becomes as routine for a user as the management of files on any of the other objects, such as hard disks or floppy disks.

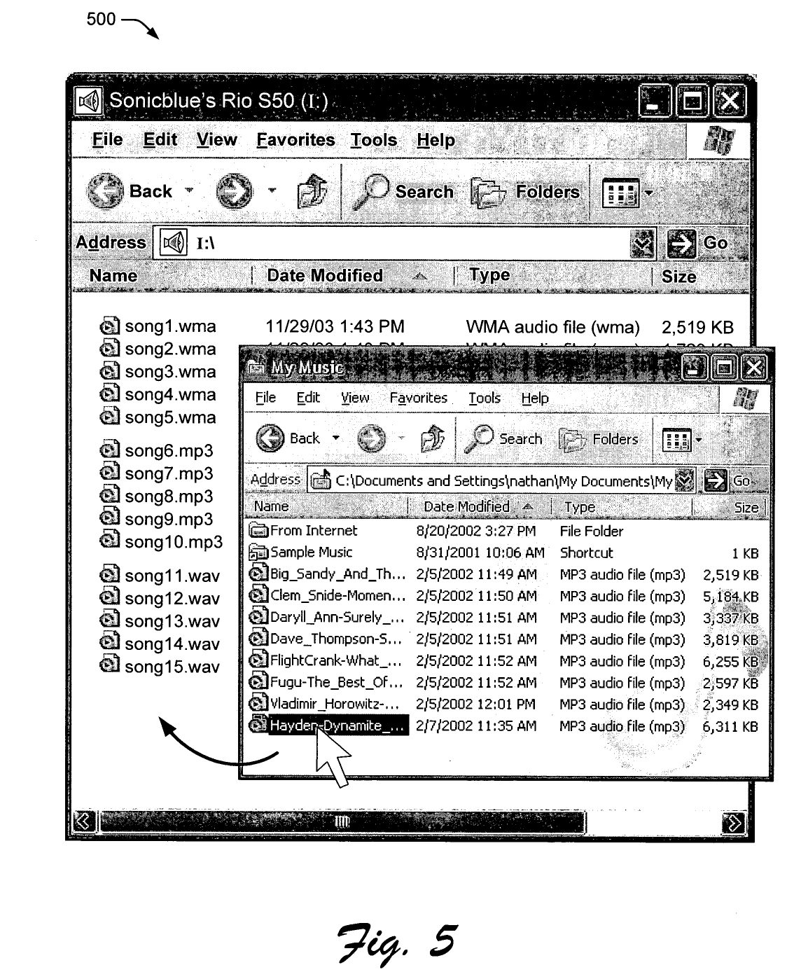

FIG. 4 illustrates an exemplary screen shot 400 generated by the OS UI 208 in response to a user input requesting to view the contents of the “Sonicblue Rio S50” 312 audio device 104. The user request is entered through the double click of a mouse over the illustrated “Sonicblue Rio S50” 312 audio device 104 in the screen shot 300 of FIG. 3. Screen shot 400 provides an exemplary view of the contents of an audio device 104. The contents include audio files in WMA, MP3 and WAV file formats. The illustrated file formats in screen shot 400 are shown by way of example only, and are not necessarily intended to indicate that any particular audio device 104 supports such a combination of file formats.

From the exemplary screen shot 400, a user can manage audio files on the audio device 104 in the same manner that files are managed on any of the storage devices of PC 102. Thus, a user can select a song by clicking on it with a mouse, and delete the selected song through several available inputs provided by the OS UI 208. For example, the user may select “delete” from within a drop down box under the “File” tab to delete a selected file. A user can also “right click” on a file to select the file, which opens a selection box 402 from which a user can select a “delete” option. The selection box 402 of FIG. 4 indicates that a user has “right clicked” on “song5.wma” 404 (highlighted). The OS UI 208 has generated the selection box 402 from which the user may now choose various options regarding what functions to perform on the selected file, “song5.wma” 404. A user can perform numerous other file management functions regarding files on an audio device 104, such as copying files, renaming files, and moving files, in any manner made available by the OS UI 208.

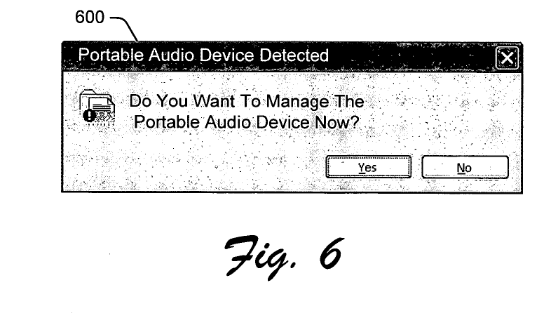

One such file management function is illustrated by the two exemplary screen shots 500 of FIG. 5, wherein a familiar OS UI 208 “drag and drop” method is demonstrated for transferring a file from one object to another. In this case, a song file called “Hayden-Dynamite” has been selected (highlighted) from the “My Music” folder in the Windows OS UI 208, and is being “dragged” (i.e., transferred or copied) to the audio device 104. This is possible because the audio device UI module 210 has created a namespace extension for the audio device 104 through which the audio device can be managed in the same consistent manner as other objects in the OS UI 208.

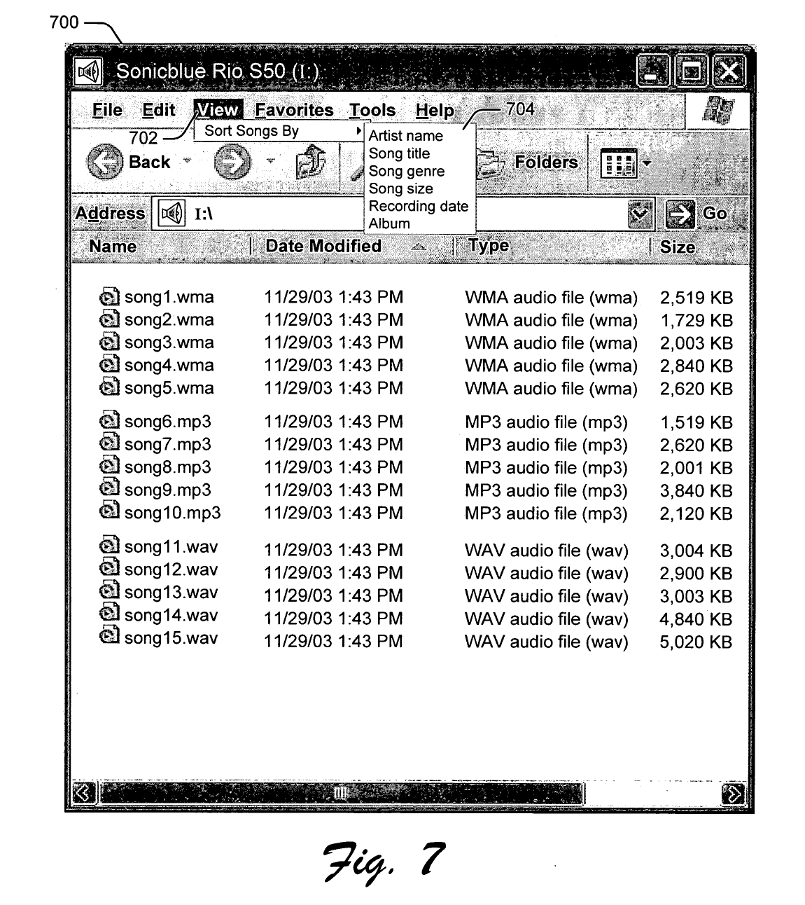

In another embodiment, upon connection of a compatible audio device 104 to PC 102, in addition to automatically providing an “Audio Devices” namespace 308, the OS UI 208 automatically notifies the user that a compatible audio device 104 has been connected to PC 102 and provides an easy entry point for the user to begin managing files on the audio device 104. The notification may be manifest in various ways, including, for example, as a dialog box which asks if the user wants to manage the audio device 104 at the current time. FIG. 6 provides an exemplary screen shot 600 showing an example of a dialog box that may be suitable for providing a notification that a connected audio device 104 has been detected and for offering an easy entry point for the user to begin managing files on the audio device 104. If the user selects “Yes” in the dialog box, the OS UI 208 may open up a screen shot 300 such as that shown in FIG. 3, providing the user with access to the connected audio device 104.

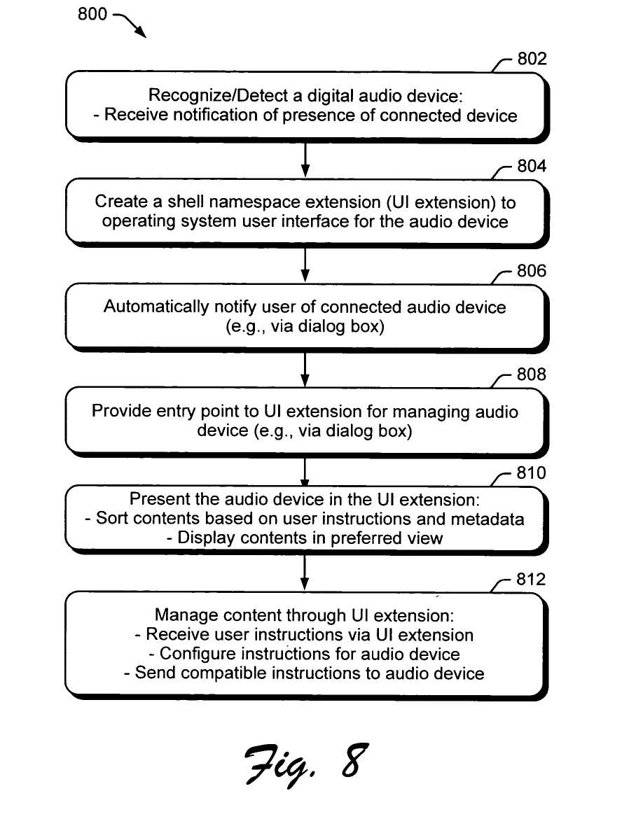

In addition to providing a consistent UI experience for viewing and managing files on an audio device 104, the audio device UI module 210 also provides a feature for sorting songs (audio/music files) on the audio device 104 based on metadata that is included in the music files. The metadata in audio files, such as MP3 files or WMA files includes information such as artist names, song titles, song genres, song sizes, song recording dates, and song albums. Thus, a user can choose to view the songs on an audio device 104 in a particular order as sorted based on various metadata. FIG. 7 provides an exemplary screen shot 700 showing an example of how a user might choose to view the file contents of an audio device 104 in a particular order. The example shows how a user can select the “View” tab 702 from the control bar, and then proceed to select how the song files on the audio device 104 should be listed according to one of the illustrated selectable factors 704 that include Artist name, Song title, Song genre, Song size, Recording date, and Album. It is noted that these are only examples of ways in which the song files may be sorted, and are not intended as limitations on how song files may be sorted on an audio device 104. In addition, preferred user views may be preset by a user to automatically sort a user's song files into a view when the file contents of an audio device 104 is displayed.

Exemplary Methods

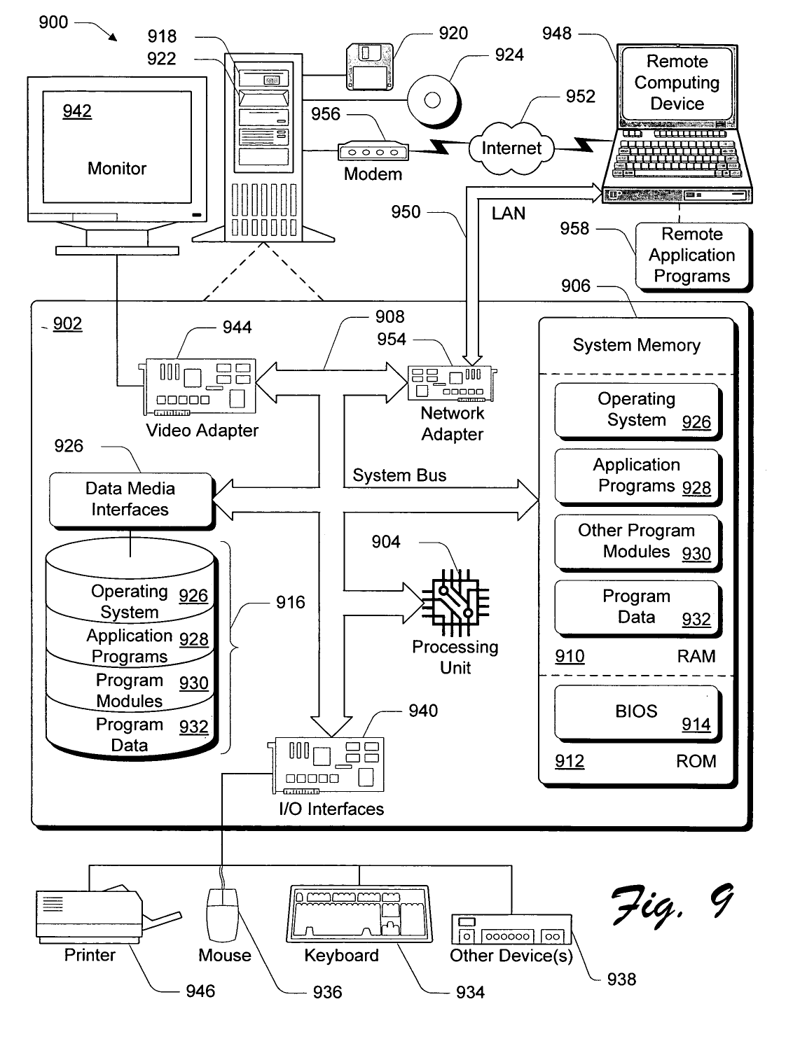

Example methods for providing management of content on a portable digital audio device 104 through an operating system user interface (OS UI) will now be described with primary reference to the flow diagram of FIG. 8. The methods apply to the exemplary embodiments discussed above with respect to FIGS. 1-7. It is noted that the elements of the described methods do not necessarily have to be performed in the order in which they are presented, and that alternative orders may result in similar advantages. The elements of the described methods may be performed by any appropriate means including, for example, by hardware logic blocks on an ASIC or by the execution of processor-readable instructions defined on a processor-readable medium.

A “processor-readable medium,” as used herein, can be any means that can contain, store, communicate, propagate, or transport instructions for use or execution by a processor. A processor-readable medium can be, without limitation, an electronic, magnetic, optical, electromagnetic, infrared, or semiconductor system, apparatus, device, or propagation medium. More specific examples of a processor-readable medium include, among others, an electrical connection (electronic) having one or more wires, a portable computer diskette (magnetic), a random access memory (RAM) (magnetic), a read-only memory (ROM) (magnetic), an erasable programmable-read-only memory (EPROM or Flash memory), an optical fiber (optical), a rewritable compact disc (CD-RW) (optical), and a portable compact disc read-only memory (CDROM) (optical).

At block 802 of method 800, PC 102 recognizes/detects that a digital audio device 104 has been connected to the PC 102. The recognition is the result of the audio device UI module 210 receiving a notification that the device 104 has been connected. Depending on the implementation, the notification may come directly from the device 104 to the audio device UI module 210, or it may come by way of a media device manager 206 which translates communications between the audio device UI module 210 and the audio device 104.

At block 804, a shell namespace extension (UI extension) is created to the operating system user interface. The UI extension for the audio device 104 is organized into a hierarchical namespace within the shell with other objects that are on or connected to PC 102. Organization of the objects in the hierarchical namespaces provides the user with a consistent and efficient way to access and manage each of these objects. File management tasks for connected audio device 104 are therefore similar to file management tasks for any of the other objects, such as hard disks or floppy disks.

At block 806, a user is automatically notified that an audio device 104 has been connected to the PC 102. The notification may come, for example, in the form of a dialog box which indicates an audio device 104 has been detected. At block 808, an entry point is provided to the UI extension so a user can gain easy access for managing the audio device 104. The entry point may be presented, for example, within the dialog box as a query as to whether a user wants to manage the audio device 104 that has been detected.

At block 810, the audio device 104 is presented in the UI extension. Presenting the audio device 104 in the UI extension can include displaying contents of the audio device 104 in the UI extension or sorting the contents according to various metadata that is included within the contents, and then displaying a view of the contents based on how the contents have been sorted. Sorting the contents of the audio device 104 includes receiving user preference instructions (e.g., via the operating system user interface) regarding a preferred view of the contents and creating the preferred view according to the instructions and relevant metadata.

At block 812, the content of the audio device is managed through the UI extension. The audio device UI module 210 of the operating system 200 receives user instructions through the UI extension. The instructions may include, for example, instructions to copy, delete, rename, and move files with respect to the audio device 104. The audio device UI module 210 configures the user instructions to be compatible with the audio device 104 and sends the compatible instructions to the device 104. In another embodiment, the audio device UI module 210 sends instructions to a media device manager 206 which translates the instructions to be compatible with the audio device 104. The media device manager 206 acts as a translator between the audio device UI module 210 and the audio device 104.

While one or more methods have been disclosed by means of flow diagrams and text associated with the blocks of the flow diagrams, it is to be understood that the blocks do not necessarily have to be performed in the order in which they were presented, and that an alternative order(s) may result in similar advantages. Furthermore, the methods are not exclusive and can be performed alone or in combination with one another.

Exemplary Computer

FIG. 9 illustrates an exemplary computing environment suitable for implementing a PC 102 such as that discussed above with reference to FIGS. 1-8. Although one specific configuration is shown in FIG. 9, PC 102 may be implemented in other computing configurations.

The computing environment 900 includes a general-purpose computing system in the form of a computer 902. The components of computer 902 may include, but are not limited to, one or more processors or processing units 904, a system memory 906, and a system bus 908 that couples various system components including the processor 904 to the system memory 906.

The system bus 908 represents one or more of any of several types of bus structures, including a memory bus or memory controller, a peripheral bus, an accelerated graphics port, and a processor or local bus using any of a variety of bus architectures. An example of a system bus 908 would be a Peripheral Component Interconnects (PCI) bus, also known as a Mezzanine bus.

Computer 902 includes a variety of computer-readable media. Such media can be any available media that is accessible by computer 902 and includes both volatile and non-volatile media, removable and non-removable media. The system memory 906 includes computer readable media in the form of volatile memory, such as random access memory (RAM) 910, and/or non-volatile memory, such as read only memory (ROM) 912. A basic input/output system (BIOS) 914, containing the basic routines that help to transfer information between elements within computer 902, such as during start-up, is stored in ROM 912. RAM 910 contains data and/or program modules that are immediately accessible to and/or presently operated on by the processing unit 904.

Computer 902 may also include other removable/non-removable, volatile/non-volatile computer storage media. By way of example, FIG. 9 illustrates a hard disk drive 916 for reading from and writing to a non-removable, non-volatile magnetic media (not shown), a magnetic disk drive 918 for reading from and writing to a removable, non-volatile magnetic disk 920 (e.g., a “floppy disk”), and an optical disk drive 922 for reading from and/or writing to a removable, non-volatile optical disk 924 such as a CD-ROM, DVD-ROM, or other optical media. The hard disk drive 916, magnetic disk drive 918, and optical disk drive 922 are each connected to the system bus 908 by one or more data media interfaces 926. Alternatively, the hard disk drive 916, magnetic disk drive 918, and optical disk drive 922 may be connected to the system bus 908 by a SCSI interface (not shown).

The disk drives and their associated computer-readable media provide non-volatile storage of computer readable instructions, data structures, program modules, and other data for computer 902. Although the example illustrates a hard disk 916, a removable magnetic disk 920, and a removable optical disk 924, it is to be appreciated that other types of computer readable media which can store data that is accessible by a computer, such as magnetic cassettes or other magnetic storage devices, flash memory cards, CD-ROM, digital versatile disks (DVD) or other optical storage, random access memories (RAM), read only memories (ROM), electrically erasable programmable read-only memory (EEPROM), and the like, can also be utilized to implement the exemplary computing system and environment.

Any number of program modules can be stored on the hard disk 916, magnetic disk 920, optical disk 924, ROM 912, and/or RAM 910, including by way of example, an operating system 926, one or more application programs 928, other program modules 930, and program data 932. Each of such operating system 926, one or more application programs 928, other program modules 930, and program data 932 (or some combination thereof) may include an embodiment of a caching scheme for user network access information.

Computer 902 can include a variety of computer/processor readable media identified as communication media. Communication media embodies computer readable instructions, data structures, program modules, or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared, and other wireless media. Combinations of any of the above are also included within the scope of computer readable media.

A user can enter commands and information into computer system 902 via input devices such as a keyboard 934 and a pointing device 936 (e.g., a “mouse”). Other input devices 938 (not shown specifically) may include a microphone, joystick, game pad, satellite dish, serial port, scanner, and/or the like. These and other input devices are connected to the processing unit 904 via input/output interfaces 940 that are coupled to the system bus 908, but may be connected by other interface and bus structures, such as a parallel port, game port, or a universal serial bus (USB).

A monitor 942 or other type of display device may also be connected to the system bus 908 via an interface, such as a video adapter 944. In addition to the monitor 942, other output peripheral devices may include components such as speakers (not shown) and a printer 946 which can be connected to computer 902 via the input/output interfaces 940.

Computer 902 may operate in a networked environment using logical connections to one or more remote computers, such as a remote computing device 948. By way of example, the remote computing device 948 can be a personal computer, portable computer, a server, a router, a network computer, a peer device or other common network node, and the like. The remote computing device 948 is illustrated as a portable computer that may include many or all of the elements and features described herein relative to computer system 902.

Logical connections between computer 902 and the remote computer 948 are depicted as a local area network (LAN) 950 and a general wide area network (WAN) 952. Such networking environments are commonplace in offices, enterprise-wide computer networks, intranets, and the Internet. When implemented in a LAN networking environment, the computer 902 is connected to a local network 950 via a network interface or adapter 954. When implemented in a WAN networking environment, the computer 902 includes a modem 956 or other means for establishing communications over the wide network 952. The modem 956, which can be internal or external to computer 902, can be connected to the system bus 908 via the input/output interfaces 940 or other appropriate mechanisms. It is to be appreciated that the illustrated network connections are exemplary and that other means of establishing communication link(s) between the computers 902 and 948 can be employed.

In a networked environment, such as that illustrated with computing environment 900, program modules depicted relative to the computer 902, or portions thereof, may be stored in a remote memory storage device. By way of example, remote application programs 958 reside on a memory device of remote computer 948. For purposes of illustration, application programs and other executable program components, such as the operating system, are illustrated herein as discrete blocks, although it is recognized that such programs and components reside at various times in different storage components of the computer system 902, and are executed by the data processor(s) of the computer.

### Conclusion

Although the invention has been described in language specific to structural features and/or methodological acts, it is to be understood that the invention defined in the appended claims is not necessarily limited to the specific features or acts described. Rather, the specific features and acts are disclosed as exemplary forms of implementing the claimed invention.

1. A processor-readable medium comprising processor-executable instructions configured for:
recognizing a digital audio device;
creating a shell namespace extension to an operating system user interface (UI extension) for the digital audio device;
presenting the digital audio device in the UI extension; and
managing content of the digital audio device through the UI extension.

2. A processor-readable medium as recited in claim 1, wherein the recognizing comprises receiving a notification indicating the presence of the digital audio device.

3. A processor-readable medium as recited in claim 1, wherein the managing comprises:
receiving user instructions through the UI extension;
configuring the user instructions for compatibility with the digital audio device; and
sending device compatible instructions to the digital audio device.

4. A processor-readable medium as recited in claim 3, wherein:
the receiving includes sending the user instructions to a media device manager;
the configuring comprises configuring the user instructions at the media device manager; and
the sending comprises sending the device compatible instructions to the digital audio device from the media device manager.

5. A processor-readable medium as recited in claim 3, wherein the user instructions are selected from the group comprising:
copying a file from local storage to the digital audio device;
deleting a file on the digital audio device;
moving a file between local storage and the digital audio device; and
renaming a file on the digital audio device.

6. A processor-readable medium as recited in claim 1, wherein the presenting the digital audio device comprises displaying contents of the digital audio device in the UI extension.

7. A processor-readable medium as recited in claim 6, wherein the displaying contents comprises:
sorting the contents according to metadata included in the contents; and
displaying a view of the contents according to the sorting.

8. A processor-readable medium as recited in claim 7, wherein the sorting comprises:
receiving user preference instructions regarding the view;
creating the view according to the user preference instructions and the metadata.

9. A processor-readable medium as recited in claim 7, wherein the metadata is selected form the group comprising:
artist names;
song titles;
song genres;
song sizes;
song recording dates; and
song albums.

10. A processor-readable medium as recited in claim 1, comprising further processor-executable instructions configured for, in response to the recognizing the digital audio device:
automatically notifying a user of the digital audio device; and
providing an entry point to the UI extension for managing content of the digital audio device.

11. A processor-readable medium as recited in claim 9, wherein the entry point comprises a dialog box that permits the user to open the digital audio device and manage contents of the digital audio device through the UI extension.

12. A computer comprising an audio device user interface (UI) module configured to detect the presence of an audio device and to display the audio device in an audio device namespace extension to an operating system user interface.

13. A computer as recited in claim 12, further comprising a media device manager configured to receive user instructions from the audio device UI module and to translate the user instructions into compatible instructions for the audio device.

14. A computer as recited in claim 12, further comprising at least one storage device, wherein the operating system user interface comprises:
the audio device namespace extension; and
a storage device namespace extension for the at least one storage device.

15. A method comprising presenting an audio device in an operating system user interface (OS UI).

16. A method as recited in claim 15, wherein the presenting comprises displaying audio files that are stored on the audio device.

17. A method as recited in claim 16, wherein the displaying comprises:
sorting the audio files into a preferred order based on user instructions and metadata within the audio files; and
displaying the audio files in the preferred order.

18. A method as recited in claim 15, further comprising managing content on the audio device through the OS UI.

19. A method as recited in claim 18, wherein the managing comprises:
receiving user instructions through the OS UI;
configuring the user instructions for compatibility with the audio device; and
sending device compatible instructions to the audio device.

20. A method as recited in claim 15, further comprising:
automatically notifying a user of the audio device; and
providing an entry point to the OS UI for managing content of the audio device.

21. A method as recited in claim 20, wherein the entry point comprises a dialog box that permits the user to open the audio device and manage contents of the digital audio device through the UI extension.
